(19) United States
(12) Patent Application Publication
(10) Pub. No.: US 2015/0302400 A1
(43) Pub. Date: Oct. 22, 2015

(54) DISTRIBUTED CRYPTO CURRENCY REPUTATION SYSTEM

(71) Applicant: EBAY INC., San Jose, CA (US)

(72) Inventor: Max Edward Metral, Brookline, MA (US)

(21) Appl. No.: 14/256,844

(22) Filed: Apr. 18, 2014

(51) Int. Cl. G06Q 20/38; G06Q 20/32; G06Q 40/00

(52) U.S. Cl. CPC G06Q 20/382; G06Q 40/12; G06Q 20/3226

(57) ABSTRACT

Distributed crypto currency reputation systems and methods include monitoring a crypto currency public ledger. A current crypto currency transaction is detected in the crypto currency public ledger and, in response, reputation markers may be allocated to both a payer and a payee that are involved in the current crypto currency transaction. At least some of the reputation markers are then determined to have been transferred from the payer to the payee and from the payee to the payer. When a request for reputation information for the payee or the payer is received, information associated with the transfer of the at least some of the reputation markers from the payer to the payee or from the payee to the payer may then be provided.

### BACKGROUND

1. Field of the Invention

The present invention generally relates to online and/or mobile payments and more particularly to a reputation system for distributed crypto currencies that may be used in online and/or mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Conventional payment service providers typically provide for payment by a payer to a payee through the use of payer accounts of the payer (e.g., credit accounts, banking account, and/or a variety of other payer accounts that may be provided by an account provider). For example, the payment service provider may provide a payment service account to the payer, and the payer may link one or more payer accounts to the payment service account (or the payment service account may include a payer account provided by the payment service provider). In a transaction between the payer and the payee, the payment service provider may then transfer funds from one of the payer accounts to a payee account of the payee (which may also be provided by the account providers or payment service provider). In transactions between payers and payees, transaction risk associated with the transaction is typically borne by the payee in the form of “chargebacks” by the account provider or payment service provider (i.e., a reversal of a fund transfer from the payer account to the payee account).

An alternative to the payer accounts and payee accounts provided by account providers, discussed above, is the use of distributed crypto currencies such as, for example, Bitcoin. Distributed crypto currencies are not controller by any central authority, but rather by a distributed network of computing devices that operate to confirm transfers of the crypto currency between payers and payees. Such decentralized distributed crypto currencies provide for the non-reversible transfer of the crypto currency between users in the system, as there is no central authority that mediates disputes associated with the transfer of the crypto currency between users. In other words, once a transfer has been made from a payer to a payee, there is no way to reverse that transfer unless the payee decides to transfer the crypto currency back to the payer in a new transaction. This feature of distributed crypto currencies provides a number of benefits (e.g., reduced transaction costs), but places the transaction risk on the payer. For example, if the payee does not deliver on a promise of goods or services, or such goods or services are deficient, the payer may have no recourse if the payee will not agree to provide a refund.

Thus, there is a need for an improved distributed crypto currency system.

### BRIEF DESCRIPTION OF THE FIGURES

FIG. 1 is a flow chart illustrating an embodiment of a method for providing a distributed crypto currency reputation system;

FIG. 2 is a schematic view illustrating an embodiment of an electronic coin;

FIG. 3 is a schematic view illustrating an embodiment of a reputation marker;

FIG. 4 is a schematic view illustrating an embodiment of a crypto currency public ledger;

FIG. 5 is a schematic view illustrating an embodiment of a reputation marker public ledger;

FIG. 6 is a schematic view illustrating an embodiment of a distributed crypto currency reputation system;

FIG. 7 is a screen shot view illustrating an embodiment of a user device displaying a reputation marker information screen;

FIG. 8 is a schematic view illustrating an embodiment of a networked system;

FIG. 9 is a perspective view illustrating an embodiment of a payer/payee/user device;

FIG. 10 is a schematic view illustrating an embodiment of a computer system; and

FIG. 11 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Some embodiments of the present disclosure provide systems and methods for quantifying reputations of users in a distributed crypto currency system. A crypto currency public ledger is monitored for crypto currency transactions between payers and payees. A detected crypto currency transaction between a payer and a payee results in the allocation of reputation markers to the payer and/or the payee. The reputation markers may be similar to the crypto currency used in the crypto currency transaction in that the creation and/or use of the reputation markers may be associated with a reputation marker public ledger. That reputation marker public ledger may allow for the determination of when reputation markers that have been allocated to payers and/or payees has been transferred to another user of the system (e.g., from the payer in the detected crypto currency transaction to the payee in the detected crypto currency transaction), and the transfer of reputation markers that have been allocated based on a payer/payee crypto currency transaction allows the payer and/or payee to quantify their experience with the other in the crypto currency transaction (i.e., if the payer is satisfied with the crypto currency transaction, they may allocate all of the reputation markers they receive as a result of the crypto currency transaction to the payee). When another user of the distributed crypto currency system is then considering a transaction with the payer or the payee, that user may request reputation information for the payer or payee, and the system may provide information that is associated with the transfer of reputation markers between the payer and the payee based on the detected crypto currency transaction (as well as other transfers of reputation markers to that payer or payee as a result of previous transactions). Once the payer and/or the payee participate in plurality of crypto currency transactions and receive (or do not receive) the associated reputation markers, information returned in response to a request for reputation information may include information about a plurality of reputation marker transfers based on any associated previous transactions, allowing the reputation of a payer or payee to be accessed by any user in the distributed crypto currency system.

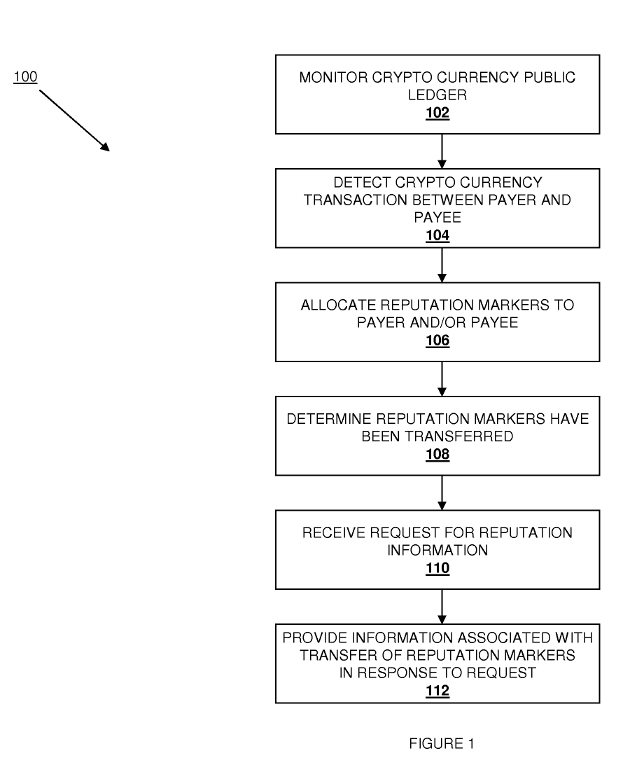

Referring now to FIGS. 1, 2, 3, 4, and 5, a method 100 for providing a distributed crypto currency reputation is illustrated. In some embodiments of the method 100 described below, one or more system provider devices may operate to perform the method 100. For example, a distributed group of devices may operate to create (a.k.a. “mine”) the distributed crypto currency, create (a.k.a. “mine”) the reputation markers, monitor transactions performed using the crypto currency (e.g., an action that may be performed during the creation of the distributed crypto currency via a crypto currency public ledger), monitor transfers performed using the reputation markers (e.g., an action that may be performed during the creation of the reputation markers via a reputation marker public ledger), and perform the method 100 as detailed below. In another embodiment, one or more system provider devices may perform the method 100 separate from the creation/monitoring of the distributed crypto currency. For example, a payment service provider such as, for example, PayPal, Inc. of San Jose, Calif., may utilize a payment service provider device to perform the method 100 discussed below, and in some embodiments may operate in cooperation with one or more other system providers (via their system provider devices), payees (via their payee devices), and/or users (via their user devices) to perform the method 100 discussed below. However, these embodiments are meant to be merely exemplary, and one of skill in the art in possession of the present disclosure will recognize that a wide variety of system providers may operate, alone or together, to provide the systems and methods discussed herein without departing from the scope of the present disclosure.

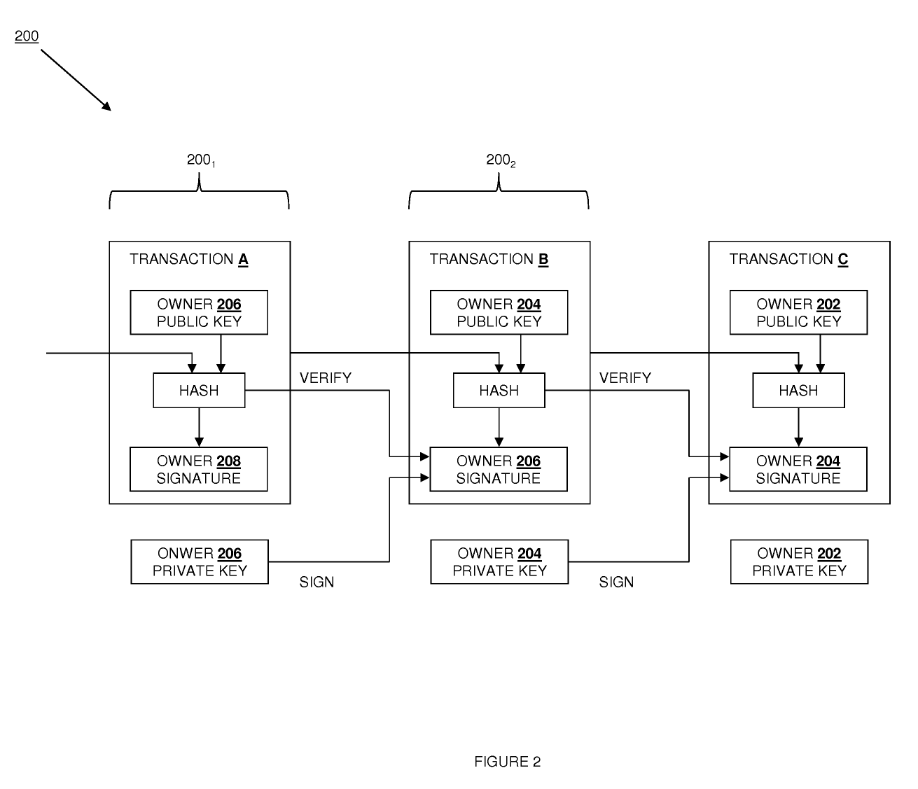

Referring now to FIG. 2, an embodiment of an electronic coin 200 is illustrated and described briefly for reference to the method 100 discussed below. The crypto currency system associated with the present disclosure defines an electronic coin as a chain of digital signatures provided by previous owners of the electronic coin to subsequent owners of the electronic coin. In the illustrated embodiment, the electronic coin 200 is owned by an owner 202, and FIG. 2 illustrates how the electronic coin 200 is defined by the digital signatures of the previous owners 204, 206, and 208. Specifically, in transaction A, a hash of the public key of owner 206 (i.e., the owner receiving, as a result of transaction A, an electronic coin 200₁ defined by digital signatures provided up to transaction A) and the previous transaction (not illustrated, but occurring prior to transaction A) was signed by owner 208 (i.e., the owner providing, as a result of transaction A, the electronic coin 200₁ defined by digital signatures provided up to transaction A) and added to an initial electronic coin (which was defined by digital signatures provided up to the transaction prior to transaction A) such that the electronic coin 200₁ was transferred to owner 206.

Similarly, in transaction B, a hash of the public key of owner 204 (i.e., the owner receiving, as a result of transaction B, an electronic coin 200₂ defined by digital signatures provided up to transaction B) and transaction A was signed by owner 206 and added to the electronic coin 200₁ such that the electronic coin 200₂ was transferred to owner 204. Similarly, in transaction C, a hash of the public key of owner 202 (i.e., the owner receiving, as a result of transaction C, the electronic coin 200 defined by digital signatures provided up to transaction C) and the transaction B was signed by owner 204 and added to the electronic coin 200₂ such that the electronic coin 200 was transferred to owner 202. As is understood in the art, any payee receiving an electronic coin (e.g., owner 206 in transaction A, owner 204 in transaction B, and owner 202 in transaction C) can verify the signatures to verify the chain of ownership of the electronic coin. In the discussion below, it should be understood that the term “electronic coins” is used to encompass any amount of electronic coins, from fractions of a coin (e.g., 0.00564500 electronic coins) to many multiples of coins (e.g., 56,000.00000000 electronic coins).

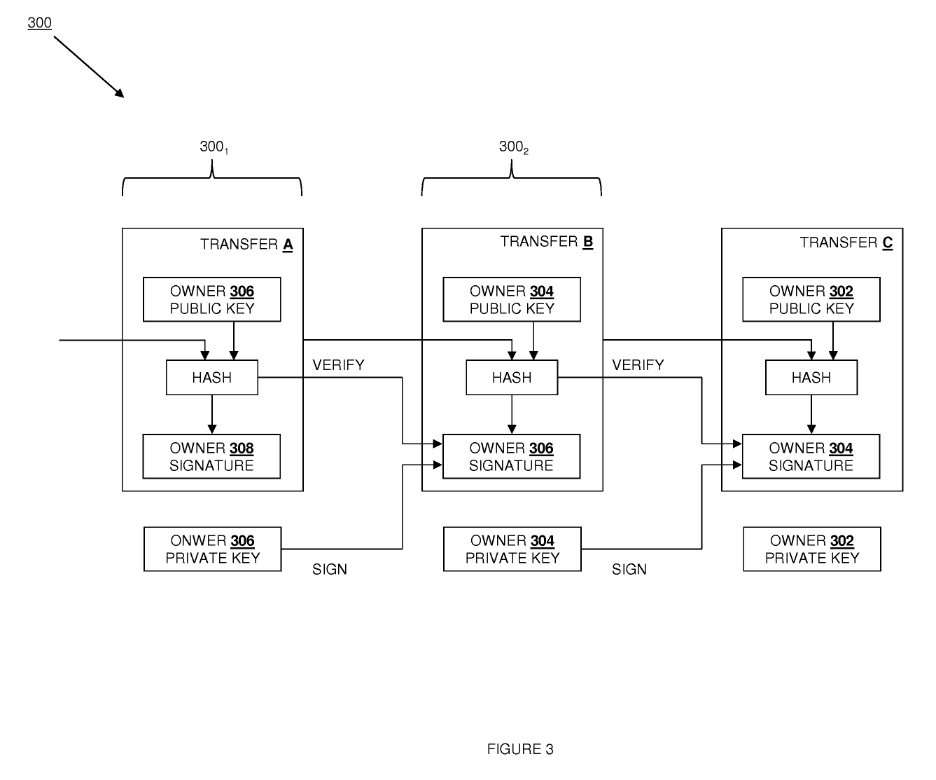

Referring now to FIG. 3, an embodiment of a reputation marker 300 is illustrated and described briefly for reference to the method 100 discussed below. The reputation marker system associated with the present disclosure may define a reputation marker in substantially the same manner as the electronic coin 200 discussed above with reference to FIG. 2—as a chain of digital signatures provided by previous owners of the reputation marker to subsequent owners of the reputation marker. In the illustrated embodiment, the reputation marker 300 is owned by an owner 302, and FIG. 3 illustrates how the reputation marker 300 is defined by the digital signatures of the previous owners 304, 306, and 308. Specifically, in transfer A, a hash of the public key of owner 306 (i.e., the owner receiving, as a result of transfer A, an reputation marker 300₁ defined by digital signatures provided up to transfer A) and the previous transfer (not illustrated, but occurring prior to transfer A) was signed by owner 308 (i.e., the owner providing, as a result of transfer A, the reputation marker 300₁ defined by digital signatures provided up to transfer A) and added to an initial reputation marker (which was defined by digital signatures provided up to the transfer prior to transfer A) such that the reputation marker 300₁ was transferred to owner 306.

Similarly, in transfer B, a hash of the public key of owner 304 (i.e., the owner receiving, as a result of transfer B, a reputation marker 300₂ defined by digital signatures provided up to transfer B) and transfer A was signed by owner 306 and added to the reputation marker 300₁ such that the reputation marker 300₂ was transferred to owner 304. Similarly, in transfer C, a hash of the public key of owner 302 (i.e., the owner receiving, as a result of transfer C, the reputation marker 300 defined by digital signatures provided up to transfer C) and the transfer B was signed by owner 304 and added to the reputation marker 300₂ such that the reputation marker 300 was transferred to owner 302. As is understood in the art of crypto currencies, any payee receiving a reputation marker (e.g., owner 306 in transfer A, owner 304 in transfer B, and owner 302 in transfer C) will be able to verify the signatures to verify the chain of ownership of the reputation marker. In the discussion below, it should be understood that the term “reputation markers” is used to encompass any amount of reputation markers, from fractions of a reputation marker (e.g., 0.00564500 reputation markers) to many multiples of reputation marker (e.g., 56,000.00000000 reputation markers).

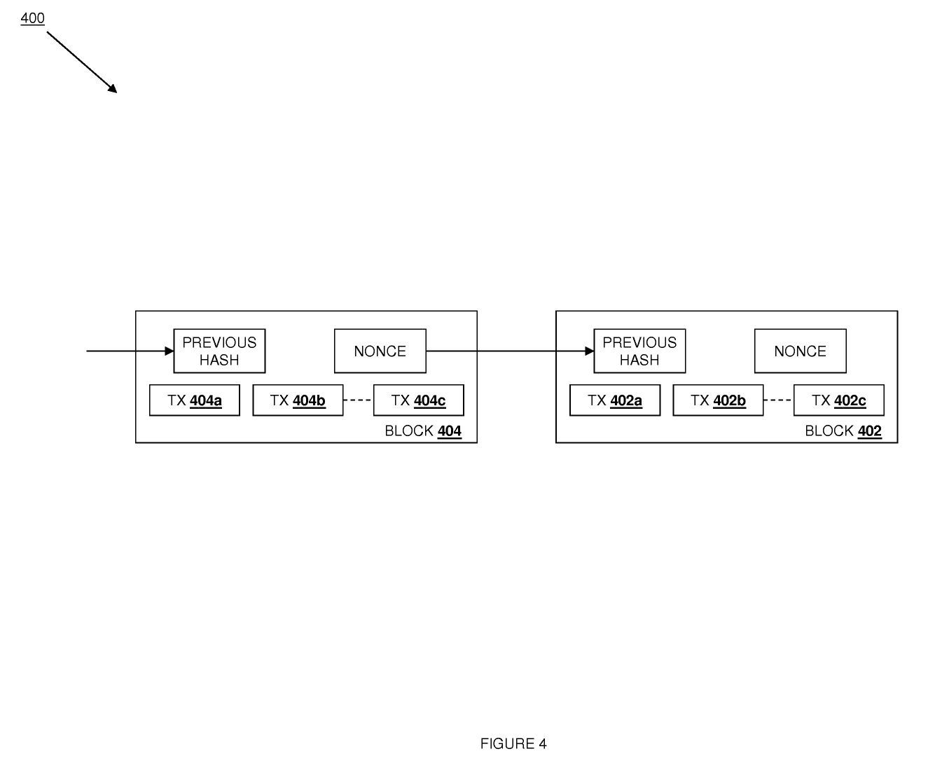

Referring now to FIG. 4, an embodiment of a crypto currency public ledger 400 is illustrated and described briefly for reference to the method 100 discussed below. The crypto currency public ledger 400 operates to verify that payers transferring an electronic coin (e.g., referring back to FIG. 2, owner 206 in transaction A, owner 204 in transaction B, and owner 202 in transaction C) did not “double-spend” (e.g., sign any previous transactions involving) that electronic coin. To produce the crypto currency public ledger 400, a distributed network of devices operates to agree on a single history of transactions in the order in which they were received such that it may be determined that a transaction between a payer and a payee using an electronic coin is the first transaction associated with that electronic coin. Each device in the distributed network operates collect new transactions into a block, and then to increment a proof-of work system that includes determining a value that when hashed with the block provides a required number of zero bits.

For example, for a block 402 that includes a plurality of transactions 402a, 402b, and up to 402c, a device in the distributed network may increment a nonce in the block 402 until a value is found that gives a hash of the block 402 the required number of zero bits. The device may then “chain” the block 402 to the previous block 404 (which may have been “chained” to a previous block, not illustrated, in the same manner). When devices in the distributed network find the proof-of-work for a block, that block (e.g., block 402) is broadcast to the distributed network, and other devices in the distributed network will accept that block if all the transactions in it are valid and not already spent (which may be determined by creating the next block using the hash of the accepted block 402). The distributed network will always consider the longest chain of blocks to be the correct one, and will operate to continue to extend it. If a device receives two different versions of a block, it will work on the first block received, but save the second block received in case the branch of the chain that includes the second block becomes longer (at which point that device with switch to working on the branch of the chain that includes the second block).

In the manner described above, a distributed crypto currency system is provided in which payers and payees may participate in transactions with each other using the electronic coins discussed above and without the need for a centralized authority such as a bank. Each of those transactions is recorded in the crypto currency public ledger to ensure that the electronic coins may only be spent by a payer once. However, as described above, the transactions in such distributed crypto currency systems are not reversible without cooperation of a payee and, as such, put a significant portion of the risk associated with the transaction on the payer. The method 100 contemplates improvements on such distributed crypto currency systems that provides for quantifying a reputation of a payee that may be retrieved by a payer prior to participating in a transaction with that payee.

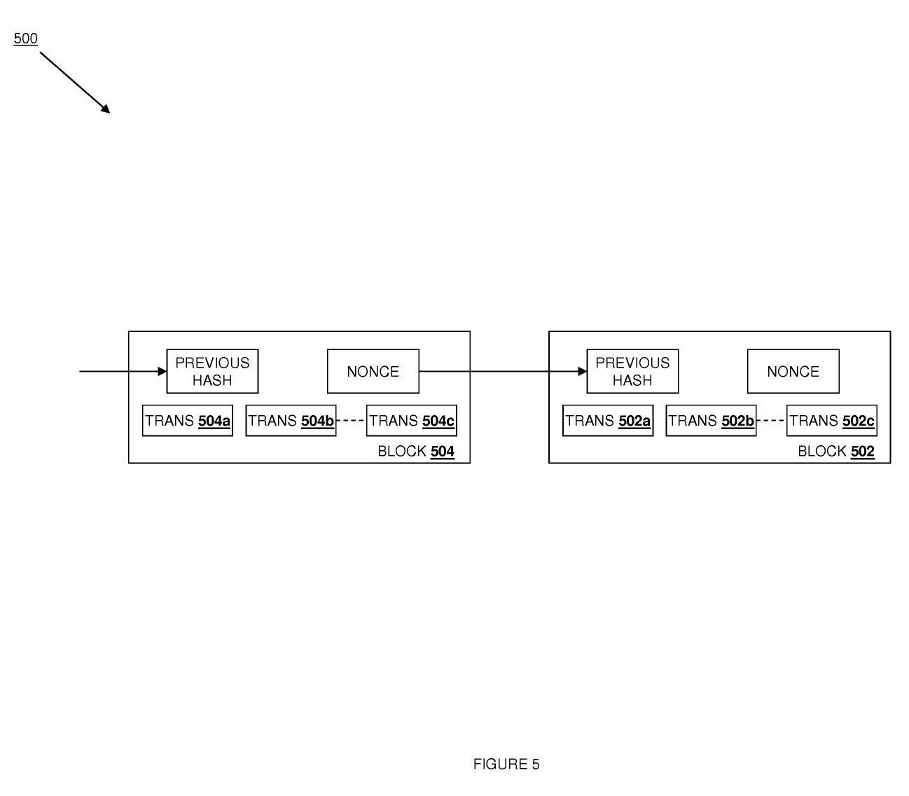

Referring now to FIG. 5, an embodiment of a reputation marker public ledger 500 is illustrated and described briefly for reference to the method 100 discussed below. The crypto currency system associated with the present disclosure may utilize the reputation marker public ledger 500 in substantially the same manner as the crypto currency ledger 400 discussed above with reference to FIG. 4—to verify that payers transferring a reputation marker (e.g., referring back to FIG. 3, owner 306 in transfer A, owner 304 in transfer B, and owner 302 in transfer C) did not “double-transfer” (e.g., sign any previous transfer involving) that reputation marker. To produce the reputation marker public ledger 500, one or more system provider devices and/or a distributed network of devices operate to agree on a single history of transfers in the order in which they were received such that it may be determined that a transfer between a payer and a payee using a reputation marker is the first transfer associated with that reputation marker. Each device operates collect new transfers into a block, and then to increment a proof-of work system that includes determining a value that when hashed with the block provides a required number of zero bits.

For example, for a block 502 that includes a plurality of transfers 502a, 502b, and up to 502c, a device may increment a nonce in the block 502 until a value is found that gives a hash of the block 502 the required number of zero bits. The device may then “chain” the block 502 to the previous block 504 (which may have been “chained” to a previous block, not illustrated, in the same manner). When the device or devices find the proof-of-work for a block, that block (e.g., block 502) may be broadcast to the distributed network or other system provider devices, and other devices will accept that block if all the transfers in it are valid and not already spent (which may be determined by creating the next block using the hash of the accepted block 502). The distributed network will always consider the longest chain of blocks to be the correct one, and will operate to continue to extend it. If a device receives two different versions of a block, it will work on the first block received, but save the second block received in case the branch of the chain that includes the second block becomes longer (at which point that device with switch to working on the branch of the chain that includes the second block).

As such, in some embodiments, the reputation markers provided in the distributed crypto currency reputation system discussed herein may operate substantially similarly to distributed crypto currencies. In some examples of those embodiments, the creation and monitoring of the reputation markers may be performed by a distributed network of computing systems, similar to crypto currencies. In fact, in some embodiments, the creations and monitoring of the reputation markers may be performed by the same distributed network of computing systems that provides the crypto currency with which they are used. In other embodiments, the creation and monitoring of the reputation markers may be performed by a central authority such as the system provider(s) discussed below. Furthermore, in some embodiments, the reputation markers may be different than the reputation marker 300 and not be associated with the reputation marker public ledger 500 described above with reference to FIGS. 3 and 5, respectively. In some examples, the reputation markers used in the distributed crypto currency reputation system may not be created and monitored like a distributed crypto currency, but rather may be generated and allocated by the system provider device(s) without public keys, signatures, private keys, and/or public ledgers. As such, a wide variety of variation in the types of reputation markers used in the distributed crypto currency reputation system are envisioned as falling within the scope of the present disclosure.

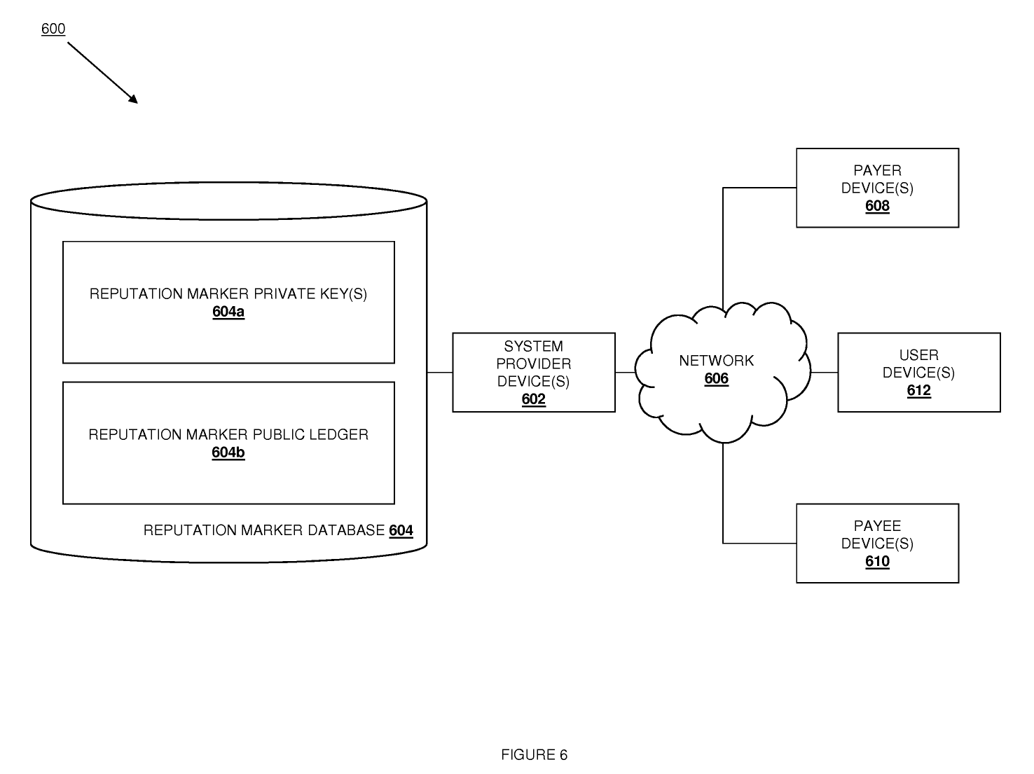

Referring now to FIGS. 1 and 6, the method 100 begins at block 102 where a crypto currency public ledger is monitored. FIG. 6 illustrates a distributed crypto currency reputation system 600 that includes one or more system provider device(s) 602 that are coupled to one or more reputation marker database(s) 604. In some embodiments, the system provider device(s) 602 may include one or more system provider devices that are connected to or otherwise have access to a reputation marker database(s). In other embodiments, the system provider device(s) 602 may be a plurality of system provider devices that each includes an identical reputation marker database that is shared with each of the system provider devices in the distributed crypto currency reputation system 600 (discussed in further detail below). The system provider device(s) 602 are couple through a network 604 (e.g., the Internet) to one or more payer devices 608, one or more payee devices 610, and/or one or more user devices 612.

As discussed in further detail below, the distributed crypto currency reputation system 600 works in conjunction with, or alongside, a distributed crypto currency system that is not explicitly illustrated in FIG. 6. However, as described above, the user devices 612 may be operated by users of the distributed crypto currency system and may be used to create and monitor the distributed crypto currency as discussed above with reference to the electronic coin 200 of FIG. 2 and the crypto currency public ledger 400 of FIG. 4. While the user device(s) 612 and the system provider device(s) 602 are illustrated as separate in FIG. 6, it should be understood that in some embodiments, the user devices 612 that provide the distributed crypto currency system may also be the system provider device(s) 602 that provide distributed crypto currency reputation system 600 and thus have access to the reputation marker database 604. However, as also discussed above, the system provider device(s) 602 may be separate from the user device(s) 612 that provide the distributed crypto currency system such that only those system provider device(s) 602 may control the creation and distribution of the reputation markers. Furthermore, while the reputation marker database 604 in the illustrated embodiment includes reputation marker private keys 604a (for allocating reputation markers to payers and payee) and a reputation marker public ledger 604b (for monitoring transfers of the reputation markers), other embodiments of the distributed crypto currency reputation system 600 may utilize reputation markers that are not associated with private keys or public ledgers.

In an embodiment of block 102, the system provider device(s) 402 monitors a crypto currency public ledger. As discussed above with reference to FIG. 4, a crypto currency public ledger is generated through a use of a crypto currency in a distributed crypto currency system. In one example of block 102, the system provider device(s) 602 may be involved in the creation of the crypto currency public ledger and may monitor that crypto currency public ledger as it is created by themselves and/or other user device(s) 612. In another example of block 102, the system provider device(s) 602 may not be involved in the creation of the crypto currency public ledger and may monitor that crypto currency public ledger as it is created by the other user device(s) 612. As is described above, a crypto currency public ledger may be created by devices incrementing a proof-of-work system on blocks of transactions to create of a chain of blocks that include valid transactions as agreed upon by the majority of those devices. At block 102, the system provider device(s) may monitor that crypto currency public ledger and, specifically, the confirmed transactions in the valid blocks that are added to the crypto currency public ledger and agreed with by a majority of the distributed network of devices.

The method 100 then proceeds to block 104 where a crypto currency transaction between a payer and a payee is detected. In an embodiment, the system provider device(s) 602 may detect any crypto currency transaction between a payer (e.g. via one of the payer devices 608) and a payee (e.g., via one of the payee devices 610) at block 104 based on the monitoring of the crypto currency public ledger at block 102. As described above with reference to FIG. 2, a crypto currency transaction is performed when a payer of electronic coins uses their private key to sign a hash the public key of payee and the previous transaction, which is then added to the electronic coin to transfer it to the payee. That transaction is broadcast to the distributed network of devices that then add it to blocks of transactions that are used to increment the proof-of-work system discussed above.

In some embodiments, a crypto currency transaction between a payer and a payee may only be “detected” by the system provider device(s) 602 in response to a minimum number of confirmations of the crypto currency transaction (i.e., the block that includes that crypto currency transaction) by the devices (e.g., the user device(s) 612, the system provider device(s) 602, etc.) that provide the distributed crypto currency system. For example, it is currently generally considered that six confirmation of a crypto currency transaction are sufficient to rely on that crypto currency transaction (i.e., to assume that that crypto currency transaction will be part of a block in the longest chain of blocks being incremented by the devices that provide the distributed crypt currency system), but more or fewer confirmations may be sufficient to detect a crypto currency transaction at block 104 of the method 100 in different embodiments of the distributed crypto currency reputation system 600. While a single crypto currency transaction between a particular payer (e.g., via their payer device 608) and a particular payee (e.g., via their payee device 610) is discussed below as being involved in blocks 106 and 108 of the method 100, one of skill in the art in possession of the present disclosure will recognize that the method 100 may operate on any crypto currency transaction occurring in the distributed crypto currency system.

The method 100 then proceeds to block 106 where reputation markers are allocated to the payer and/or the payee. In an embodiment of block 106, the system provider device(s) 602 may allocate reputation markers to the payer and/or the payee that were involved in the crypto currency transaction detected at block 104. In some embodiments, the reputation markers may be created or generated in response to the crypto currency transaction and, as such, reputation markers may come into being in response to detected crypto currency transactions. For example, the creation of the reputation markers by the system provider device(s) 602 may be linked to the detection of crypto currency transactions such that the system provider device(s) 602 operate to create the reputation markers in response to detecting the crypto currency transaction at block 104.

In these embodiments, the reputation markers may be created and allocated in an amount that is based on the detected crypto currency transaction. For example, the reputation markers may be created and allocated in an amount that is equal to the amount of electronic coins involved in the detected crypto currency transaction (e.g., a crypto currency transaction of 1.4250 electronic coins may result in the creation and allocation of 1.4250 reputation markers). In another example, the reputation markers may be created and allocated in an amount that is some percentage of the amount of electronic coins involved in the detected crypto currency transaction (e.g., a crypto currency transaction of 1.4250 electronic coins may result in the creation and allocation of 0.7125 reputation markers, or 50% of the electronic coins involved in the crypto currency transaction). In another example, the reputation markers may be created and allocated in an amount that is based on the occurrence of the detected crypto currency transaction (e.g., each detected crypto currency transaction may result in the creation and allocation of 1 reputation marker, regardless of the amount of the crypto currency transaction). As such, in these embodiments, at block 106 the reputation markers are created or generated and provided to the payer and/or the payee involved in the crypto currency transaction detected at block 104. While a few examples have been provided, any type of allocation factors may be used in allocating reputation markers based on a crypto currency transaction, and may be selected based on the most logical allocations for crypto currency transactions that will further the goal of accurately reflecting a user's reputation using the reputation markers (e.g., relatively large crypto currency transactions may be allocated more reputations markers relative to relatively small crypto currency transactions).

In another embodiment, the reputation markers may have been previously created and/or generated by the system provider device(s) 602. In these embodiments, the reputation markers may be allocated in an amount that is based on the detected crypto currency transaction similarly as described above for the reputation markers that are created in response to the detected crypto currency transaction. In some embodiments, reputation markers may not be allocated until a user (e.g., a payee) attempts to transfer reputation markers to another user (e.g., a payer). For example, the system may detect a requested transfer of reputation markers to from a payee to a payer and, in response, check the crypto currency public ledger for a crypto currency transaction corresponding to the attempted reputation marker transfer, confirm there was crypto currency transaction for allocating the attempted transfer of reputation markers, and then allocate the reputation markers to the payer as requested by the payee.

In a specific embodiment, the reputation markers allocated at block 106 are substantially similar to the reputation marker 300 described above with reference to FIG. 3 and are associated with a reputation marker public ledger that is substantially similar to the reputation marker public ledger 500 described above with reference to FIG. 5. Referring to FIG. 6, the allocation of the reputation markers at block 106 may include the system provider device(s) conducting a transfer, discussed above with reference to FIG. 3, using the reputation marker private key(s) 604a in the reputation marker database 604 to transfer the allocated reputation markers to the payer and/or the payee involved in the crypto currency transaction detected at block 104. As such, in some embodiments following block 106, the payer and/or the payee involved in the crypto currency transaction detected at block 104 become the owners of the reputation markers that are allocated at block 106. However, in other embodiments, the reputation markers may be controlled by the system provider device(s) 602 and allocated to the payer and/or the payee such they are associated with the payer and/or the payee (e.g., in the reputation marker database 604) but are still under the control of the system provider device(s) 602.

Thus, for each detected crypto currency transaction occurring in the distributed crypto currency system, reputation markers may be allocated to the parties in that detected crypto currency transaction. While the allocation of reputation markers has been described above as involving actions may by the system provider device(s) 602 that may be actively performed by the system provider(s), such actions may be automated in reputation marker provision software on the system provider device(s) 602 that monitors the crypto currency public ledger 400 and automatically allocates the reputation markers to the parties involved in each crypto currency transaction performed and confirmed in the crypto currency public ledger 400. Furthermore, reputation markers may be allocated for crypto currency transactions in a single type of crypto currency (e.g., Bitcoin), or may be allocated for crypto currency transactions across multiple types of crypto currency (e.g., Bitcoin, Litecoin, etc.). As such, the system provider devices may monitor multiple crypto currency public ledgers to detect transactions and allocate reputation markers to any parties in those transactions, regardless of the type of crypto currency that is being used in those transactions.

The method 100 then proceeds to block 108 where it is determined that reputation markers have been transferred. In an embodiment, the system provider device(s) 602 monitor the reputation marker public ledger 604b that is continuously updated in the reputation marker database 604 to determine when reputation markers have been transferred between users in the distributed crypto currency reputation system 600. For example, when the allocation of the reputation markers at block 106 makes the payer and/or the payee the owners of the reputation markers, the transfer of reputation markers from an owner of the reputation markers may be broadcast to the system provider device(s) 602 such that it is included in the reputation marker public ledger 500, and thus the monitoring of the reputation marker public ledger 500 will allow for the detection of the transfer of those reputation markers. In some embodiments, the transfer of reputation markers from a payee to a payer may include the payee signing the reputation marker with their payee private/public key pair that was used in the crypto currency transaction in order to prevent the need for mapping between the crypto currency system and the reputation marker system. However, such mappings may be performed in other embodiments.

In another embodiment, the system provider device(s) 602 control the reputation markers such that a transfer of reputation markers between users in the distributed crypto currency reputation system 600 must be conducted through the system provider device(s) 602. For example, when the allocation of the reputation markers at block 106 associates the payer and/or the payee with the reputation markers in the reputation marker database 604, a request to transfer reputation markers to a second user may be sent from the first user associated with those reputation markers to the system provider device(s) 602, and thus the detection of the transfer of those reputation markers by the system provider device(s) 602 occurs and the system provider device(s) operate to associated the second user with those reputation markers while disassociating the first user with those reputation markers.

In different embodiments, the transfer of reputation markers between users in the distributed crypto currency reputation system 600 may include some restrictions. In one embodiment, the transfer of reputation markers may be restricted such that those reputation markers may only be transferred to the other party of a crypto currency transaction. For example, a payer may receive reputation markers in response to a detected crypto currency transaction with a payee, and that payer may be restricted to transferring those reputation markers to that payee for that detected crypto currency transaction. In another embodiment, the transfer of reputation markers may be restricted such that those reputation markers may only be transferred to the other party of a crypto currency transaction, but that transfer may be performed for any of a plurality of different crypto currency transaction with that payee. For example, a payer may receive reputation markers in response to a current detected crypto currency transaction with a payee, and that payer may be restricted to transferring those reputation markers to that payee for any of a plurality of detected crypto currency transactions (e.g., prior detected crypto currency transactions, the current detected crypto currency transaction, or subsequent detected crypto currency transactions) with that payee. In another embodiment, the transfer of reputation markers may be restricted such that those reputation markers may only be transferred within a predetermined time of the allocation of those reputation markers. For example, a payer may receive reputation markers in response to a current detected crypto currency transaction with a payee, and that payer may be restricted to transferring those reputation markers within 48 hours of receiving them. As such, in some embodiments, reputation markers may be unallocated, transferred away from, or otherwise made unusable by the user to which they were transferred after a predetermined amount of time.

While a few examples of reputation marker transfer restrictions have been provided, one of skill in the art in possession of the present disclosure will recognize that any of a variety of restrictions on the transfer of reputation markers will fall within the scope of the present disclosure. Furthermore, in some embodiments there may be no restrictions on the transfer of reputation markers such that a payer receiving reputation markers may transfer them to any other party that was involved in a previous or subsequent crypto currency transaction with that payer. Further still, while the restrictions above have been directed to restrictions on the transfer of reputation markers by a payer, they may be applied similarly to restricting transfers of reputation markers allocated to payee.

Thus, the performance of block 108 results in the tracking of the transfer of reputation markers between users of the distributed crypto currency reputation system, and in particular embodiments, between payers and payees that have been involved in crypto currency transactions with each other using the distributed crypto currency system. The transfer of reputation markers between payers and payees that have been involved in a crypto currency transaction allows the payers and the payees to express their satisfaction with the associated crypto currency transaction. For example, a payer may transfer electronic coins to a payee and receive products or services in response. If the payee is satisfied with the products or services received, the payer may then transfer all the reputation coins allocated based on that transaction to the payee to indicate that satisfaction. Similarly, if the payee is unsatisfied with the products or services received, the payer may then transfer none, or only some, of the reputation coins allocated based on that transaction to the payee to indicate that dissatisfaction. In some embodiments, the system providers and/or the users of the distributed crypto currency reputation system may create, develop, or otherwise determine the amounts of reputation markers that should be transferred to another party to a crypto currency transaction based on different levels of satisfaction or dissatisfaction with a crypto currency transaction.

The method 100 then proceeds to block 110 where a request is received for reputation information. In an embodiment, the system provider device(s) 60 may receive a request for reputation information for any user of the distributed crypto currency reputation system from any other user of the distributed crypto currency reputation system. In a specific example, a user of the distributed crypto currency reputation system may send a request for reputation information about the payer that was involved in the detected crypto currency transaction with the payee at block 104 above. In some embodiments, the system provider device(s) 602 may provide a website, application, and/or other communication means to allow users of the distributed crypto currency reputation system to send the request for reputation information to the system provider device(s) 602. A request for reputation information may specify a user of the distributed crypto currency reputation system for which reputation information is being requested, information about a proposed transaction with that user (e.g., an amount of the proposed transaction, a type of the proposed transaction, and/or a variety of other transaction information known in the art), and/or any other information that is collected by the system provider device(s) about the crypto currency transactions and reputation marker transfers discussed above.

The method 100 proceeds to block 112 where information associated with the transfer of reputation markers is provided in response to the request. In some embodiments, the system provider device(s) 602 may review the reputation marker public ledger 604b that is continuously updated in the reputation marker database 604 to retrieve information about the transfer of reputation markers to the user that was specified in the request for reputation information. As discussed above, the reputation marker public ledger 604b details the transfers of reputation markers between users, and may allow for any or all transfers of reputation markers to the user specified in the request for reputation information to be retrieved. In some embodiments, the system provider device(s) 602 may update the reputation marker database 604 with information retrieved about the transfer of reputation markers to users in the distributed crypto currency reputation system, which allows the system provider device(s) to quickly retrieve information about the transfers of reputation markers to the user that was specified in the request for reputation information. Furthermore, in embodiments where the system provider device(s) 602 control the reputation markers and allocate them to users of the distributed crypto currency reputation system, the system provider device(s) may reference the reputation marker database 604 for any given user to retrieve a history of reputation marker transfers to that user.

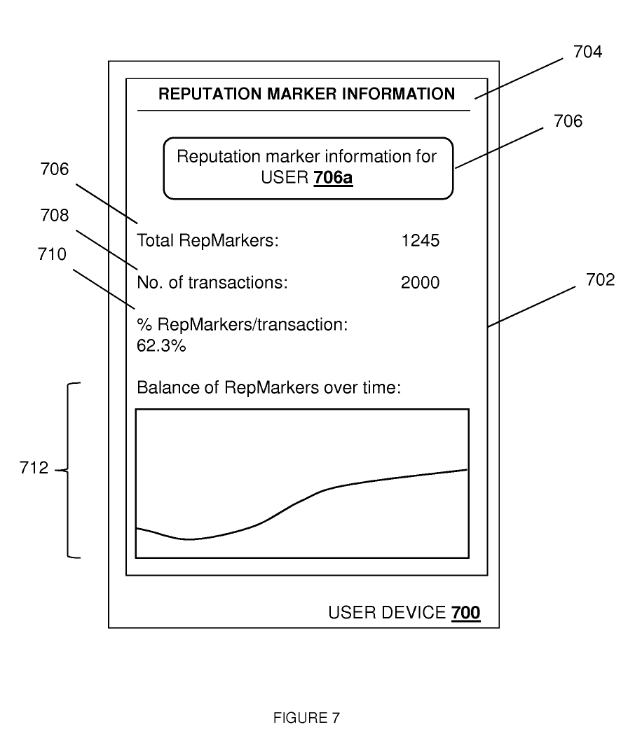

The system provider device(s) 602 may then provide the information associated with the transfer of reputation markers to the user that was specified in the request for reputation information to the user (e.g., via their user device 612 over the network 606) that provided that request. FIG. 7 illustrates an embodiment of a user device 700 with a display device 702 displaying a reputation marker information screen 704 that was provided by the system provider device(s) 602 over the network 606 to the user device 700. The reputation marker information screen 704 includes a user identifier 706 that identifies a user 706a for which the reputation information was requested at block 110 and retrieved. In the illustrated embodiment, that reputation information includes a total number of reputation markers 706 that have been transferred to the user 706a (e.g., 1245 reputation markers transferred by payers in previous crypto currency transactions with the payee/user 706a), a number of crypto currency transactions 708 that the user 706a has been involved in (e.g., 2000 crypto currency transactions between the user 706a and other users that resulted in allocated reputation markers), a percentage of reputation markers the user 706a receives per transaction (e.g., the user 706a receives, on average, 62.3% of the reputation markers allocated to a given crypto currency transaction), and a balance of reputation markers over time 712 (e.g., a tracking of the reputation markers transferred to the user 706a over time—in some embodiments, reputation markers transferred to a user 706a may expire and be disassociated with the user 706a such that the balance of reputation markers transferred to the user 706a may reduce). While a few examples have been provided, one of skill in the art in possession of the present disclosure will recognize that information provided on the reputation marker information screen 704 may include any information stored, monitored, and tracked in the reputation marker database 604 while remaining within the scope of the present disclosure.

Thus, the systems and methods of the present disclosure allow the user of the user device 700 to retrieve, view, and analyze the reputation marker information provided by the system provider device(s) 602 to determine how other users of the distributed crypto currency reputation system that have been involved in crypto currency transactions with a given user have felt about those crypto currency transactions. This provides any user of the distributed crypto currency reputation system the ability to determine a reputation of any other user in order to determine whether to participate in a crypto currency transaction with that user, and allows users of the distributed crypto currency reputation system to express satisfaction or dissatisfaction with any crypto currency transaction they participate in. As such, the risk borne by payers in a distributed crypto currency system may be reduced by allowing those users some degree of knowledge about how other users of the distributed crypto currency system feel about a user they are about to transact with, and that degree of knowledge may be used to determine whether or not to participate in a crypto currency transaction with that user.

Furthermore, because of the nature of crypto currency public ledgers (i.e., that they include every crypto currency transaction conducted in the history of the crypto currency), the distributed crypto currency reputation system may be used to go “back in time” and reward reputation markers to payers and/or payees for previous crypto currency transactions. As such, the system provider device(s) 602 may analyze the crypto currency public ledger to detect a plurality of previous crypto currency transactions between various payers and payees, and allocate reputation markers to those payers and payees substantially as described above.

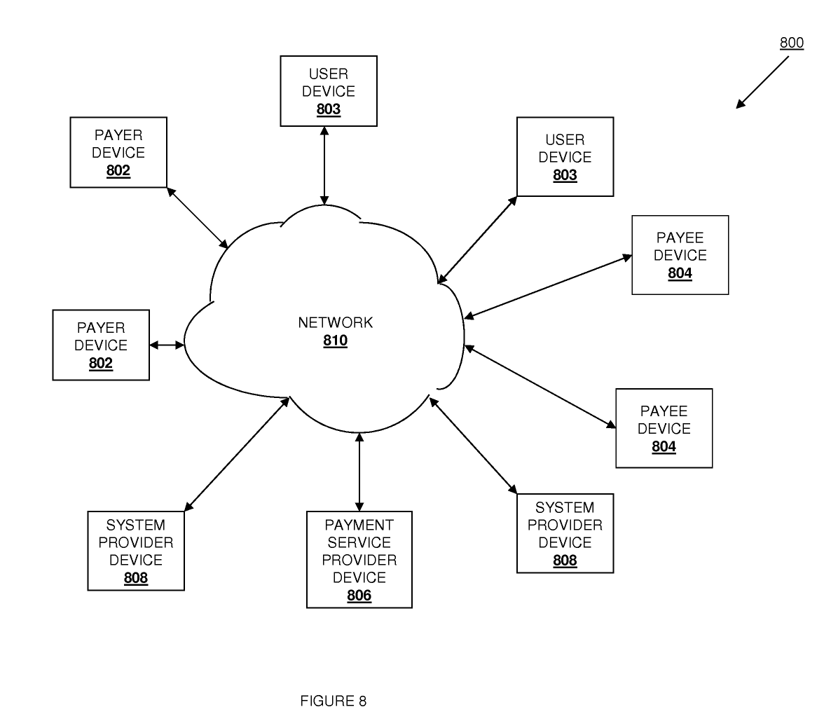

Referring now to FIG. 8, an embodiment of a networked system 800 used in the distributed crypto currency reputation system described above is illustrated. The networked system 800 includes a plurality of payer devices 802, a plurality of user devices 803, a plurality of payee devices 804, a payment service provider device 806, and/or a plurality of system provider devices 808 in communication over a network 810. Any of the payer devices 802 may be the payer devices operated by the payers, discussed above. Any of the user devices 803 may be the user devices operated by the users, discussed above. Any of the payee devices 804 may be the payee devices operated by the payees, discussed above. The payment service provider device 806 may be the payment service provider devices discussed above and may be operated by a payment service provider such as, for example, PayPal Inc. of San Jose, Calif. Any of the system provider devices 808 may be the system provider devices operated by the system providers, discussed above.

The payer devices 802, user devices 803, payee devices 804, payment service provider device 806, and/or system provider devices 808 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 800, and/or accessible over the network 810.

The network 810 may be implemented as a single network or a combination of multiple networks. For example, in various embodiments, the network 810 may include the Internet and/or one or more intranets, landline networks, wireless networks, and/or other appropriate types of networks.

The payer devices 802 may be implemented using any appropriate combination of hardware and/or software configured for wired and/or wireless communication over network 810. For example, in one embodiment, the payer devices 802 may be implemented as a personal computer of a user in communication with the Internet. In other embodiments, the payer devices 802 may be a smart phone, wearable computing device, laptop computer, and/or other types of computing devices.

The payer devices 802 may include one or more browser applications which may be used, for example, to provide a convenient interface to permit the payer to browse information available over the network 810. For example, in one embodiment, the browser application may be implemented as a web browser configured to view information available over the Internet.

The payer devices 802 may also include one or more toolbar applications which may be used, for example, to provide user-side processing for performing desired tasks in response to operations selected by the payer. In one embodiment, the toolbar application may display a user interface in connection with the browser application.

The payer devices 802 may further include other applications as may be desired in particular embodiments to provide desired features to the payer devices 802. In particular, the other applications may include a payment application for payments assisted by a payment service provider through the payment service provider device 806. The other applications may also include security applications for implementing user-side security features, programmatic user applications for interfacing with appropriate application programming interfaces (APIs) over the network 810, or other types of applications. Email and/or text applications may also be included, which allow the payer to send and receive emails and/or text messages through the network 810. The payer devices 802 include one or more user and/or device identifiers which may be implemented, for example, as operating system registry entries, cookies associated with the browser application, identifiers associated with hardware of the payer devices 802, or other appropriate identifiers, such as a phone number. In one embodiment, the user identifier may be used by the payee devices 804, the payment service provider device 806, and/or the system provider devices 808 to associate the payer with a particular account as further described herein.

The payee devices 804 may be maintained, for example, by a conventional or on-line merchant, conventional or digital goods seller, individual seller, and/or application developer offering various products and/or services in exchange for payment to be received conventionally or over the network 810. In this regard, the payee devices 804 may include a database identifying available products and/or services (e.g., collectively referred to as items) which may be made available for viewing and purchase by the payee.

The payee devices 804 also include a checkout application which may be configured to facilitate the purchase by the payer of items. The checkout application may be configured to accept payment information from the payers through the payer devices 802 and/or from the payment service provider through the payment service provider device 806 over the network 810.

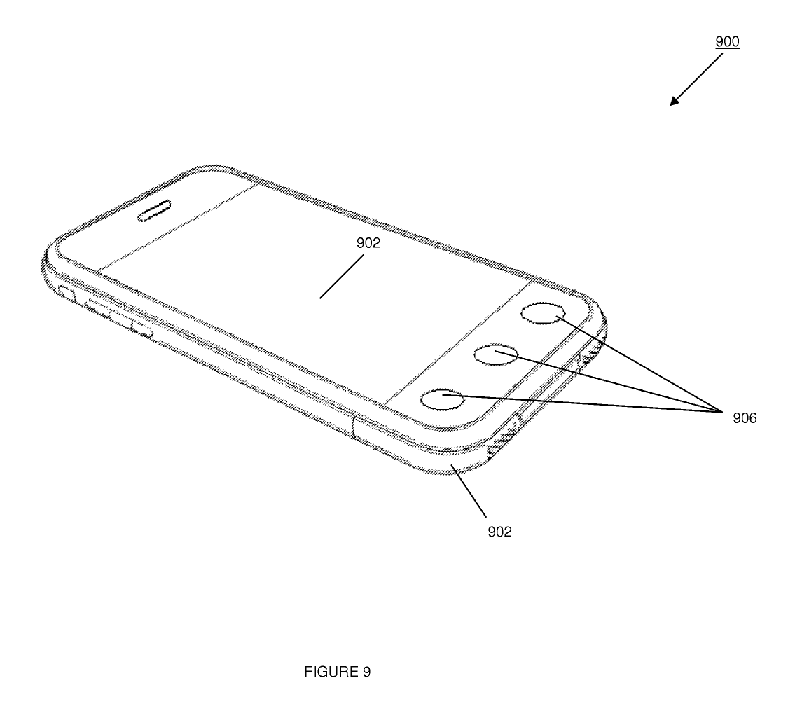

Referring now to FIG. 9, an embodiment of a payer/payee/user device 900 is illustrated. The device 900 may be any of the payer devices, payee devices, and/or user devices discussed above. The device 900 includes a chassis 902 having a display 904 and an input device including the display 904 and a plurality of input buttons 906. One of skill in the art will recognize that the device 900 is a portable or mobile phone including a touch screen input device and a plurality of input buttons that allow the functionality discussed above with reference to the method 100. However, a variety of other portable/mobile devices and/or desktop devices may be used in the method 100 without departing from the scope of the present disclosure.

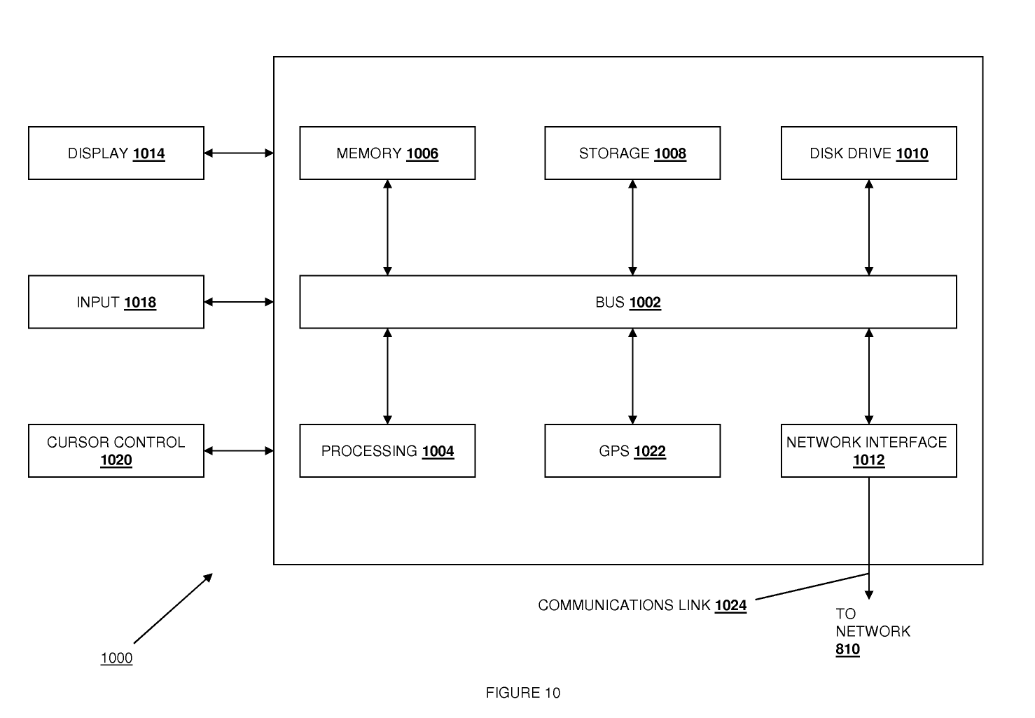

Referring now to FIG. 10, an embodiment of a computer system 1000 suitable for implementing, for example, the payer devices, user devices, payee devices, payment service provider device, and/or system provider devices, is illustrated. It should be appreciated that other devices utilized by payers, payees, users, payment service providers, and/or system providers in the distributed crypto currency reputation system discussed above may be implemented as the computer system 1000 in a manner as follows.

In accordance with various embodiments of the present disclosure, computer system 1000, such as a computer and/or a network server, includes a bus 1002 or other communication mechanism for communicating information, which interconnects subsystems and components, such as a processing component 1004 (e.g., processor, micro-controller, digital signal processor (DSP), etc.), a system memory component 1006 (e.g., RAM), a static storage component 1008 (e.g., ROM), a disk drive component 1010 (e.g., magnetic or optical), a network interface component 1012 (e.g., modem or Ethernet card), a display component 1014 (e.g., CRT or LCD), an input component 1018 (e.g., keyboard, keypad, or virtual keyboard), a cursor control component 1020 (e.g., mouse, pointer, or trackball), and/or a location determination component 1022 (e.g., a Global Positioning System (GPS) device as illustrated, a cell tower triangulation device, and/or a variety of other location determination devices known in the art). In one implementation, the disk drive component 810 may comprise a database having one or more disk drive components.

In accordance with embodiments of the present disclosure, the computer system 1000 performs specific operations by the processor 1004 executing one or more sequences of instructions contained in the memory component 1006, such as described herein with respect to the payer devices, payee devices, user devices, payment service provider devices, and/or system provider devices. Such instructions may be read into the system memory component 1006 from another computer readable medium, such as the static storage component 1008 or the disk drive component 1010. In other embodiments, hard-wired circuitry may be used in place of or in combination with software instructions to implement the present disclosure.

Logic may be encoded in a computer readable medium, which may refer to any medium that participates in providing instructions to the processor 1004 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1010, volatile media includes dynamic memory, such as the system memory component 1006, and transmission media includes coaxial cables, copper wire, and fiber optics, including wires that comprise the bus 1002. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1000. In various other embodiments of the present disclosure, a plurality of the computer systems 1000 coupled by a communication link 1024 to the network 810 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1000 may transmit and receive messages, data, information and instructions, including one or more programs (i.e., application code) through the communication link 1024 and the network interface component 1012. The network interface component 1012 may include an antenna, either separate or integrated, to enable transmission and reception via the communication link 1024. Received program code may be executed by processor 1004 as received and/or stored in disk drive component 1010 or some other non-volatile storage component for execution.

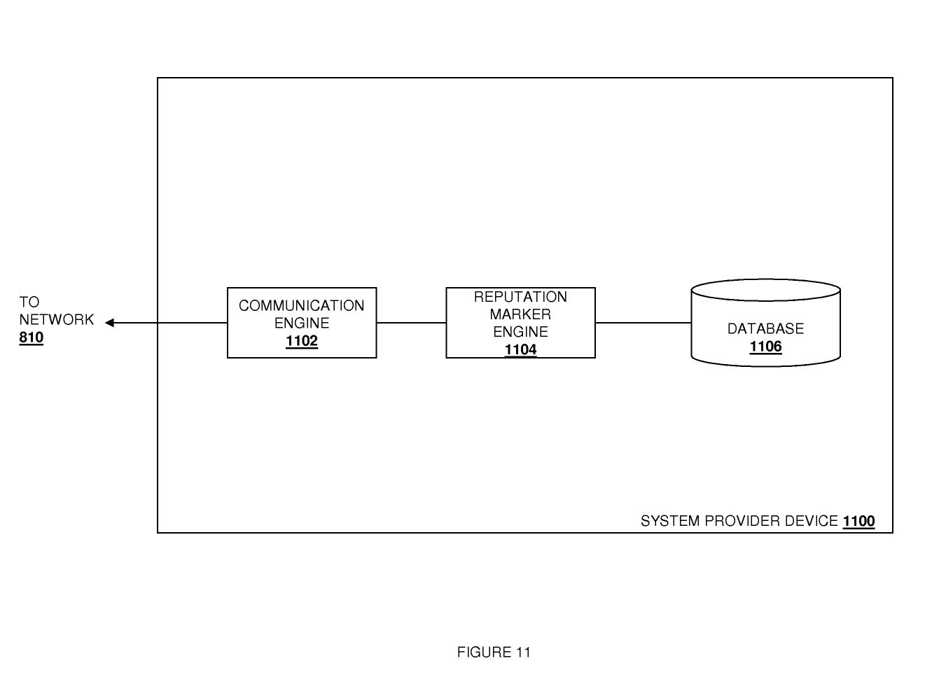

Referring now to FIG. 11, an embodiment of a system provider device 1100 is illustrated. In an embodiment, the device 1100 may be any of the system provider devices discussed above. The device 1100 includes a communication engine 1102 that is coupled to the network 810 and to a reputation marker engine 1104 that is coupled to a database 1106. The communication engine 1102 may be software or instructions stored on a computer-readable medium that allows the device 100 to send and receive information over the network 810. The reputation marker engine 1104 may be software or instructions stored on a computer-readable medium that is operable to monitor crypto currency ledgers, detect crypto currency transactions, allocate reputation markers to payers and/or payees associated with a detected crypto currency transaction, determine markers have been transferred, receive requests for reputation information, provide information associated with transfers of reputation markers in response to a received request for reputation information, and/or provide any of the other functionality that is discussed above. While the database 1106 has been illustrated as a single database located in the device 110, one of skill in the art will recognize that it may include multiple databases and be connected to the reputation marker engine 1104 through the network 810 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payers and payees; however, a payer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A distributed crypto currency reputation system, comprising:
a non-transitory memory; and
one or more hardware processors coupled to the memory and operable to read instructions from the memory to perform the steps of:
monitoring a crypto currency public ledger;
detecting a current crypto currency transaction in the crypto currency public ledger and, in response, allocating reputation markers to a payer that is involved in the current crypto currency transaction with a payee;
determining that at least some of the reputation markers have been transferred from the payer to the payee; and
receiving a request for reputation information for the payee and, in response, providing information associated with the transfer of the at least some of the reputation markers from the payer to the payee.

2. The system of claim 1, wherein the one or more hardware processors are operable to read instructions from the memory to perform the steps of:
allocating reputation markers to the payee that is involved in the current crypto currency transaction with the payer in response to detecting the current crypto currency transaction;
determining that at least some of the reputation markers have been transferred from the payee to the payer; and
receiving a request for reputation information for the payer and, in response, providing information associated with the transfer of the at least some of the reputation markers from the payee to the payer.

3. The system of claim 1, wherein the determining that the at least some of the reputation markers have been transferred from the payer to the payee includes monitoring a reputation marker public ledger.

4. The system of claim 1, wherein the reputation markers that are allocated to the payer are restricted such that those reputation markers are only transferrable by the payer to the payee for the current crypto currency transaction.

5. The system of claim 1, wherein the reputation markers are allocated to the payer in a reputation marker amount that based on a crypto currency amount of the crypto currency transaction.

6. The system of claim 1, wherein the information that is associated with the transfer of the at least some of the reputation markers from the payer to the payee and that is provided in response to the request for reputation information is included in a total amount of reputation markers transferred to the payee as a result of a plurality of crypto currency transactions.

7. A method for providing a distributed crypto currency reputation, comprising:
monitoring, by one or more system provider devices over a network, a crypto currency public ledger;
detecting, by the one or more system provider devices over the network, a current crypto currency transaction in the crypto currency public ledger and, in response, allocating reputation markers to a payer that is involved in the current crypto currency transaction with a payee;
determining, by the one or more system provider devices, that at least some of the reputation markers have been transferred from the payer to the payee; and
receiving, by the one or more system provider devices over the network, a request for reputation information for the payee and, in response, providing information over the network that is associated with the transfer of the at least some of the reputation markers from the payer to the payee.

8. The method of claim 7, further comprising:
allocating, by the one or more system provider devices, reputation markers to the payee that is involved in the current crypto currency transaction with the payer in response to detecting the current crypto currency transaction;
determining, by the one or more system provider devices, that at least some of the reputation markers have been transferred from the payee to the payer; and
receiving, by the one or more system provider devices over the network, a request for reputation information for the payer and, in response, providing information over the network that is associated with the transfer of the at least some of the reputation markers from the payee to the payer.

9. The method of claim 7, wherein the determining that the at least some of the reputation markers have been transferred from the payer to the payee includes monitoring a reputation marker public ledger.

10. The method of claim 7, wherein the reputation markers that are allocated to the payer are restricted such that those reputation markers are only transferrable by the payer to the payee for any of a plurality of different transactions between the payer and the payee.

11. The method of claim 7, wherein the reputation markers are allocated to the payer in a reputation marker amount that based on the occurrence of the current crypto currency transaction.

12. The method of claim 7, wherein the information that is associated with the transfer of the at least some of the reputation markers from the payer to the payee and that is provided in response to the request for reputation information is included in an amount of reputation markers transferred to the payee per transaction as a result of a plurality of crypto currency transactions.

13. The method of claim 7, further comprising:
analyzing, by the one or more system provider devices over the network, the crypto currency public ledger; and
detecting, by the one or more system provider devices, a previous crypto currency transaction and, in response, allocating reputation markers to a previous payer that was involved in the previous crypto currency transaction with a previous payee.

14. A non-transitory computer-readable medium comprising instructions which, in response to execution by a computer system, cause the computer system to perform a method comprising:
monitoring a crypto currency public ledger;
detecting a current crypto currency transaction in the crypto currency public ledger and, in response, allocating reputation markers to a payer that is involved in the current crypto currency transaction with a payee;
determining that at least some of the reputation markers have been transferred from the payer to the payee; and
receiving a request for reputation information for the payee and, in response, providing information associated with the transfer of the at least some of the reputation markers from the payer to the payee.

15. The non-transitory machine-readable medium of claim 14, wherein the method further comprises:
allocating reputation markers to the payee that is involved in the current crypto currency transaction with the payer in response to detecting the current crypto currency transaction;
determining that at least some of the reputation markers have been transferred from the payee to the payer; and
receiving a request for reputation information for the payer and, in response, providing information associated with the transfer of the at least some of the reputation markers from the payee to the payer.

16. The non-transitory machine-readable medium of claim 14, wherein the determining that the at least some of the reputation markers have been transferred from the payer to the payee includes monitoring a reputation marker public ledger.

17. The non-transitory machine-readable medium of claim 14, wherein the reputation markers that are allocated to the payer are unrestricted such that those reputation markers may be transferred to any other party in a previous or subsequent crypto currency transaction with the payer.

18. The non-transitory machine-readable medium of claim 14, wherein the reputation markers are allocated to the payer in response to detecting a minimum number of confirmations of the current crypto currency transaction.

19. The non-transitory machine-readable medium of claim 14, wherein the information that is associated with the transfer of the at least some of the reputation markers from the payer to the payee and that is provided in response to the request for reputation information is included in a balance of reputation markers for the payee over time.

20. The non-transitory machine-readable medium of claim 14, wherein the method further comprises:
analyzing the crypto currency public ledger; and
detecting a plurality of previous crypto currency transactions and, in response, allocating reputation markers to each respective previous payer and previous payee that were involved in each of the plurality of previous crypto currency transactions.
